(19) United States
(12) Patent Application Publication
(10) Pub. No.: US 2002/0107778 A1
(43) Pub. Date: Aug. 8, 2002

(54) Methods and systems for funding purchase transactions

(76) Inventor: Sean Daly, Breda (NL)

Correspondence Address: John S. Beulick, Armstrong Teasdale LLP, Suite 2600, One Metropolitan Sq., St. Louis, MO, 63102, US

(21) Appl. No.: 09/779,711

(22) Filed: Feb. 8, 2001

(51) Int. Cl. G06F 17/60

(52) U.S. Cl. 705/37; 705/39

(57) ABSTRACT

Methods and systems for simplifying, and increasing the speed, of initiating and closing purchase transactions are described. In an exemplary embodiment, and upon acceptance of goods/services by the buyer, a funding source makes payment to the appropriate supplier. In the sales agreement between the buyer and the supplier, and in return for early payment, the supplier agrees to extend a reduced purchase price, i.e., initial purchase price less a variable merchant fee. Once the buyer accepts the goods/services, the buyer notifies the funding source and the funding source makes payment to the supplier on behalf the buyer. The payment made to the supplier from the funding source is reduced by an amount equal to the variable merchant fee in return for the early payment. The buyer, however, makes payment to the funding source with no reduction, but at a later date, i.e., on the agreed upon payment date.

### BACKGROUND OF THE INVENTION

This invention relates generally to methods and systems for facilitating funding of transactions relating to the purchase of goods and services and more particularly to methods and systems for determining pre-payment terms.

In a typical transaction for a purchase of goods, a buyer requests a supplier to submit a quote for supplying the goods. A typical supplier quote includes both an amount to be paid as well as payment terms, e.g., the date on which payment is due. If the buyer has secured funding for the purchase, and after the buyer negotiates a final sales price and terms, the buyer then notifies the funding source of the transaction. The funding source makes payment to the supplier based on the negotiated sales price on the negotiated due date, and the buyer agrees to pay the funding source in accordance with the funding agreement terms.

The entity serving as the funding source typically takes a security interest in the goods which are the subject of the transaction in order to provide protection against a breach by the buyer. In order to perfect such a security interest, a security interest agreement is prepared, the agreement is executed by the buyer, and the agreement is recorded in the appropriate jurisdiction. Obtaining and perfecting the security interest requires resources and time, and therefore adds to the cost of the funding arrangement. In addition, if the goods and the buyer are located in different countries, i.e., a cross border transaction, the complexities associated with perfecting and enforcing a security interest further increase the transaction costs.

If the buyer defaults, the funding source then typically enforces the security interest rights, which might include taking possession of and selling the goods. Of course, enforcing such rights is time consuming and can be expensive. In addition, while such a sale of the repossessed goods may enable the lender to recover at least some amount of money, such a sale does not necessarily result in a full recovery by the funding source.

Further, and as explained above, in the event that the buyer is located in a jurisdiction different from a jurisdiction in which the goods are located (e.g., a cross border transaction), perfecting the security interest as well as enforcing the security interest can be difficult, if not impossible. The complexity of the transaction, as well as the time required to complete the transaction, adversely impact the cost and risk of extending funding for the transaction.

### BRIEF SUMMARY OF THE INVENTION

In one aspect, an exchange is provided which includes a prepayment wizard for establishing a variable merchant fee (VMF). The supplier can accept pre-payment in return for reducing the selling price by an amount equal to the VMF. The buyer, however, pays the full selling price to the funding source on a date later than the pre-payment date. The VMF earned by the funding source accounts for the risk undertaken in connection with extending funding for the purchase. Therefore, rather than incurring the costs associated with obtaining, perfecting, and possibly enforcing a security interest, the risk incurred by the funding source in extending the funding is covered by the VMF.

More specifically, and in one embodiment, a funding source (e.g., a bank or other financial institution) agrees to extend funding to a buyer for use in purchasing goods. The specific terms on which such funding are extended can take many forms including a commercial credit arrangement. Generally, the terms of the funding agreement provide that upon acceptance of goods by the buyer, the funding source makes payment to the appropriate supplier, and the buyer pays the funding source within an agreed upon time period.

With respect to the exchange, and in the exemplary embodiment, the buyer electronically issues a request for bids through the exchange on, for example, a wide area network such as the Internet. Suppliers enter the exchange and view the request. When submitting a bid in response to the request via the exchange, a pre-payment wizard screen is displayed to the supplier. Generally, the pre-payment wizard provides the supplier with an opportunity to accept payment earlier than the payment date specified in the bid in return for a reduction from the purchase price. The purchase price is reduced by an amount equal to a variable merchant fee, which is described below in more detail.

If the supplier selects pre-payment terms, the wizard requests the supplier to enter a supplier number. If the supplier has not been to the wizard site before, the supplier will not have a number and therefore will enter into a registration process. The registration process is utilized to obtain supplier contact information as well as agreement to exchange terms and conditions. At the completion of the registration process, the supplier is once again queried to enter a supplier number.

Once an authorized supplier number is entered, the wizard determines, based on risk based pricing or buyer determined tiers, a yield curve for the supplier in relation to that buyer. The yield curve is then used to determine prepayment options, and the wizard then displays to the supplier the options, if any, on pre-payment terms. Once the supplier selects a particular pre-payment arrangement, the payment terms and transactions details are stored by the wizard in an exchange database.

After the buyer accepts the goods, the buyer notifies (e.g., electronically through the exchange, by fax, or otherwise) the funding source to make payment to the supplier on behalf of the buyer. The payment made to the supplier is reduced by an amount equal to the VMF in return for the early payment. The buyer, however, makes payment to the funding source with no reduction, but at a later date, i.e., on the agreed upon payment date.

The buyer receives the products/services by the required date and secures the advantage of retaining cash for the full period prior to payment becoming due under the terms and conditions of the funding agreement. The supplier receives payment earlier than the usual terms, i.e., the supplier receives payment in (Y−a) days rather than in Y days, and also should have enhanced confidence in receipt of payment since the buyer has been approved by the funding source, i.e., the funding source has determined that the buyer has an acceptable payment history and credit rating to participate in the funding arrangement. The funding source earns the variable merchant fee for the prepayment and since the transaction is similar to a commercial credit arrangement, the funding source only needs to deal with the buyer in terms of analyzing credit rating, past history, and collectability. Further, since the funding source ensures the liquidity of the buyer to make the payment as specified in the funding agreement, the risk associated with the funding is covered in the VMF and the funding source need not take a security interest in the goods.

### BRIEF DESCRIPTION OF THE DRAWINGS

FIG. 1 is a flow chart illustrating process steps for a purchase transaction;

FIG. 2 is a flow chart illustrating process steps executed by the pre-payment wizard referenced in FIG. 1;

FIG. 3 is a block diagram of a client-server system;

FIG. 4 is a block diagram of a network based system;

FIGS. 5 is a flow chart illustrating another embodiment of process steps for a transaction;

FIGS. 6 and 7 are a flow chart illustrating yet another embodiment of process steps for a transaction; and

FIG. 8 illustrates curves for determining the variable merchant fee and invoice payment dates.

### DETAILED DESCRIPTION OF THE INVENTION

Set forth below is a description of exemplary methods and systems for facilitating, and closing purchase transactions. The systems and methods are not limited to practice with any particular type of goods or services, and can be used in many different contexts. For example, the systems and methods can be utilized for purchases by a single buyer from one seller, by one buyer from multiple sellers, and by multiple buyers from multiple sellers.

Further, although the various embodiments are described herein in the context of utilization of computers and networks (e.g., local area networks, wide area networks such as the Internet), such embodiments are not limited to practice in electronic form. For example, a buyer who deals with only a very few suppliers for particular types of goods and/or services need not necessarily implement the processes electronically.

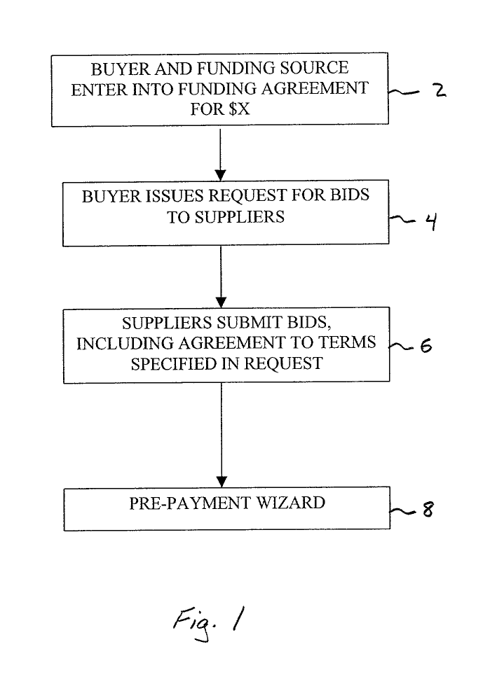

FIG. 1 is a flow chart illustrating process steps for a purchase transaction. As shown in FIG. 1, a buyer and a funding source enter into a funding agreement (e.g., a commercial credit agreement) for $X to be used to purchase goods 2. In order to qualify a buyer for a certain amount of funding, the funding source generally requires that the funding be subject to an acceptable level of risk. Many different processes and metrics can be utilized in determining whether the particular buyer qualifies for a certain level of funding. For example, if a particular buyer has entered into previous funding arrangements with the funding source, then the payment history on those agreements can be used. In addition, credit history information for a particular buyer can be purchased, for example, from Dun & Bradstreet and other credit bureaus. Credit information that can be used includes the industry code for the buyer, agency ratings, and balance sheet information.

Of course, the method illustrated in FIG. 1 can be practiced not only with new buyers, but also with existing buyers who have pre-established credit limits. For such existing buyers, there is no need for the funding source and buyer to establish a new funding agreement. If the credit limit of the existing buyer is not exceeded by the purchase amount for the particular purchase, i.e., the purchase price does not result in the buyer exceeding its credit limit, then the buyer is approved and the wizard is displayed.

Even if the purchase amount would result in exceeding the credit limit of a particular buyer, the buyer may still be approved if, for example, the next payment due by the buyer would result in bringing the buyer back within its credit limit and the buyer has a payment history with no defaults. Of course, an overusage fee may be charged to the buyer in such a circumstance. In addition, the funding source could provide that for certain buyers, the credit limit can be increased to enable funding for a particular purchase. For example, buyers with no defaults in their payment history are candidates for having their credit limits increased.

With funding in place, the buyer issues a request for bids, or quotes, to suppliers 4. The request, in the exemplary embodiment, is issued electronically through an exchange on, for example, a wide area network such as the Internet. The supplier enters the exchange and views the terms of the request.

Once the supplier enters a bid in response to a request 6, a pre-payment wizard screen is displayed to the supplier if the buyer is approved for pre-payment funding 8. If the buyer is not approved for pre-payment, then the prepayment wizard is not utilized.

Generally, if the buyer is approved and the pre-payment wizard is displayed to the supplier, the pre-payment wizard provides the supplier with an opportunity to accept payment terms for payment earlier than the payment date specified in the request in return for a reduction from the purchase price. The amount of the reduction is sometimes referred to herein as a variable merchant fee (VMF). An exemplary process for determining a VMF is described below in more detail.

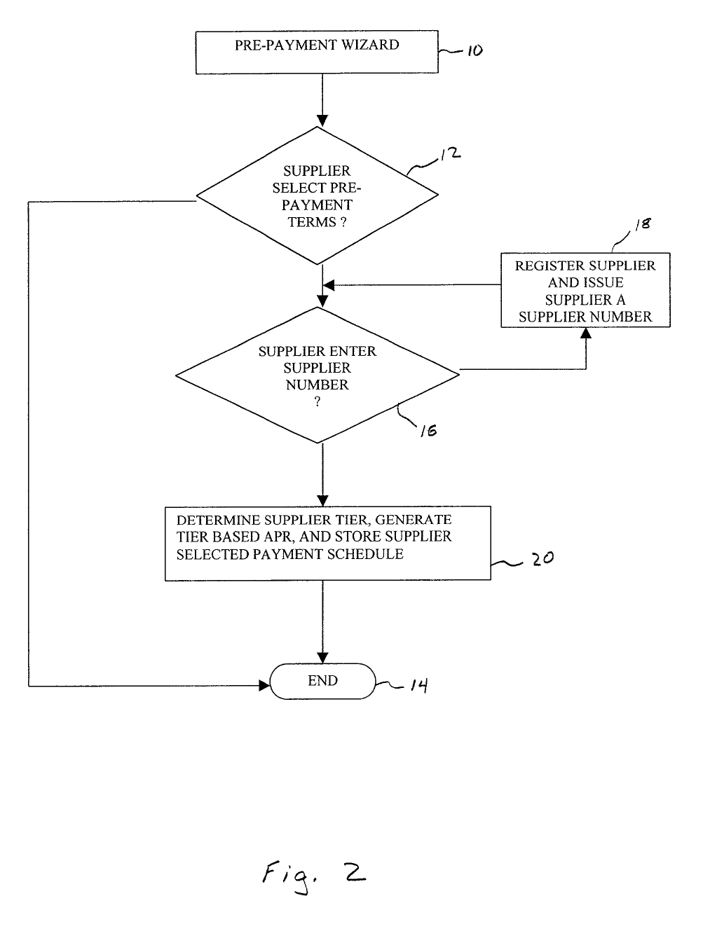

FIG. 2 is a flow chart illustrating process steps executed by the pre-payment wizard referenced in FIG. 1. The term “wizard” as used herein refers to a sequence of steps executed by a computer and dependent upon user selections. Using the pre-payment wizard 10, for example, the supplier can select prepayment terms 12. If the supplier does not select pre-payment terms, then the wizard processing ends 14 and the PO terms and conditions are utilized for the transaction. If the supplier selects pre-payment terms, the wizard requests the supplier to enter a supplier number 16.

If the supplier has not been to the wizard site before, the supplier will not have a number and therefore will enter into a registration process. During the registration process 18, the supplier enters contact information, banking information (e.g., electronic funds transfer banking information), and agrees to terms and conditions for participation in the exchange. At the completion of the registration process, the supplier is once again queried to enter a supplier number 16.

Once the supplier provides a valid supplier number, the wizard determines, based on risk based pricing or buyer determined tiers, a yield curve for the supplier in relation to the relevant buyer 20. The yield curve is then used to determine pre-payment options as described below in more detail, and the wizard then displays to the supplier the options, if any, on pre-payment terms. Once the supplier selects a particular pre-payment arrangement, the payment terms and transactions details are stored by the wizard in an exchange database.

After the buyer accepts the goods, the buyer notifies the funding source to make payment to the supplier on behalf of the buyer. Such notification can be made electronically through the exchange (e.g., via e-mail), by fax, telephone, or otherwise. The payment made to the supplier is reduced by the applicable VMF in return for the early payment. The buyer, however, makes payment to the funding source with no reduction from the purchase price, but at a later date, i.e., on the agreed upon payment date.

The process described above provides numerous advantages for the buyer, the supplier, and the funding source. For example, for the buyer, the buyer receives the products/services required with acceptable payment terms, e.g., the buyer does not have to make payment for Y days. For the supplier, the supplier receives payment earlier than the usual terms, i.e., the supplier receives payment in (Y−a) days. Further, the supplier should have enhanced confidence in receipt of payment since the buyer has been approved by the funding source, i.e., the funding source has determined that the buyer has an acceptable payment history and credit rating to extend the funding. For the funding source, the funding source earns the variable merchant fee. Also, the funding source only needs to deal with the buyer in terms of analyzing credit rating, past history, and collectability. Further, with respect to cross-border transactions, the funding source does not have to deal with the complexities of factoring of receivables, security interests, and enforceability of collection rights.

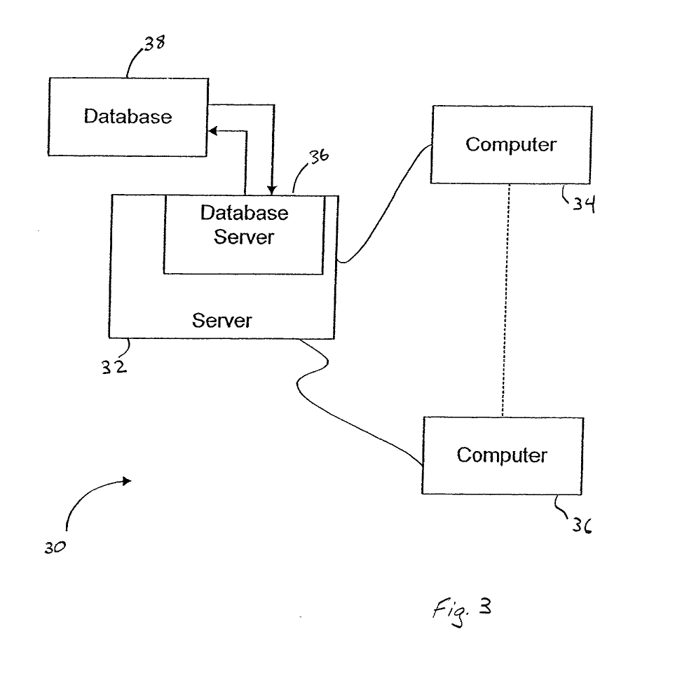

While the process described above need not be implemented electronically, FIG. 3 illustrates an exemplary system architecture which can be utilized in practicing the process. More specifically, FIG. 3 is a block diagram of a system 30 that includes a server sub-system 32, sometimes referred to herein as server 32, and a plurality of devices 34 connected to server 32. In one embodiment, devices 34 are computers including a web browser, and server 32 is accessible to devices 34 via a network such as an intranet or a wide area network such as the Internet. In an alternative embodiment, devices 34 are servers for a network of devices.

Devices 34 are interconnected to the network, such as a local area network (LAN) or a wide area network (WAN), through many interfaces including dial-in-connections, cable modems and high-speed lines. Alternatively, devices 34 are any device capable of interconnecting to a network including a web-based phone or other web-based connectable equipment. Server 32 includes a database server 36 connected to a centralized database 38. In one embodiment, centralized database 38 is stored on database server 36 and is accessed by buyers and suppliers at one of devices 34 by logging onto server sub-system 32. In an alternative embodiment centralized database 38 is stored remotely from server 32.

A prospective buyer stores in database 38 information relating to various supplier arrangements, and well as specific desired purchases. The supplier can access the database 38 to obtain information regarding the buyer desired purchases and submit to the buyer, via server 32, proposed terms and conditions for sale. Such proposed terms and conditions for sale also are stored in database 38. In addition, the funding source accesses database 38 to propose terms for early payment and VMFs available pursuant to funding agreements with the buyer. Such terms also are stored on database 38.

The system described above in connection with FIG. 3 can be utilized in many different contexts, including for situations with one buyer dealing with one supplier, one buyer dealing with multiple suppliers, and multiple buyers dealing with multiple suppliers. Generally, with such a system, the buyers and suppliers are known, and the funding source can pre-negotiate funding arrangements with the buyers. The funding arrangements can take various forms including commercial credit arrangements. In the context of dealing with previously unknown buyers and previously unknown suppliers, added functionality (e.g., automated credit scoring and risk assessment as well as credit decisioning) can be beneficial in determining the basis on which funding will be extended. For example, a buyer registration wizard can be provided in connection with the qualification process for unknown buyers who desire to participate in funding. Such a system sometimes is referred to herein as an exchange.

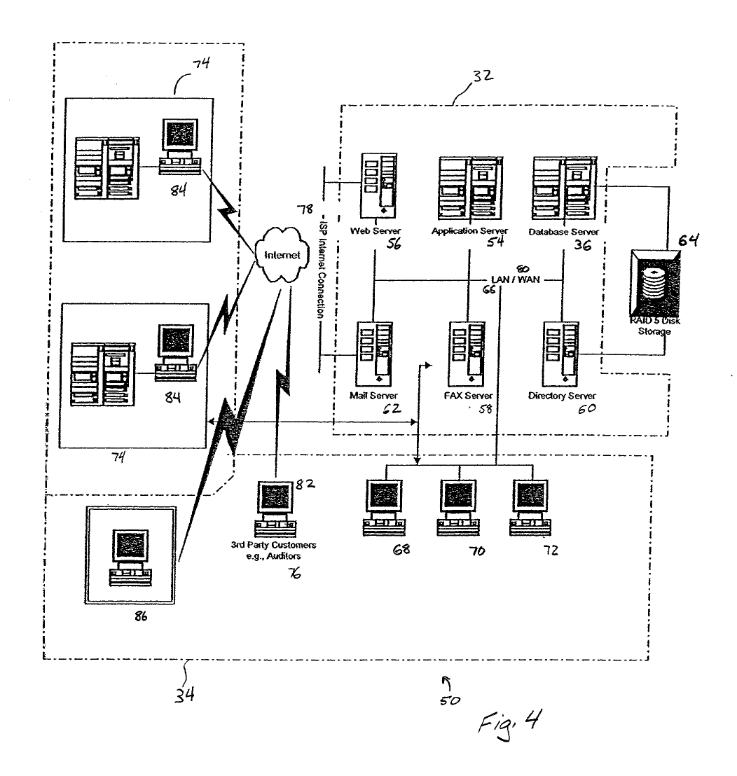

FIG. 4 is a block diagram of a network based system 50 that can be utilized in the context of establishing an exchange. System 50 also can be used for very simple purchases, e.g., one buyer and one seller, but also incorporates added functionality for facilitating many purchases by many buyers from many suppliers. System 50 is described herein from the perspective of being implemented, or hosted, by a funding source. System 50 could, however, also be implemented by buyers as well as suppliers.

More specifically, system 50 includes server sub-system 32 and customer devices 34. Server sub-system 32 includes database server 36, an application server 54, a web server 56, a fax server 58, a directory server 60, and a mail server 62. A disk storage unit 64 is coupled to database server 66 and directory server 60. Servers 66, 54, 56, 58, 60, and 62 are coupled in a local area network (LAN) 66. In addition, a system administrator work station 68, a work station 70, and a supervisor work station 72 are coupled to LAN 66. Alternatively, work stations 68, 70, and 72 are coupled to LAN 66 via an Internet link or are connected through an intranet.

Each work station 68, 70, and 72 is a personal computer including a web browser. Although the functions performed at the work stations typically are illustrated as being performed at respective work stations 68, 70, and 72, such functions can be performed at one of many personal computers coupled to LAN 66. Work stations 68, 70, and 72 are illustrated as being associated with separate functions only to facilitate an understanding of the different types of functions that can be performed by individuals having access to LAN 66.

Server sub-system 32 is configured to be communicatively coupled to various individuals or employees 74 and to third parties, e.g., customers and suppliers, 76 via an ISP Internet connection 78. The communication in the exemplary embodiment is illustrated as being performed via the Internet, however, any other wide area network (WAN) type communication can be utilized in other embodiments, i.e., the systems and processes are not limited to being practiced via the Internet. In addition, and rather than a WAN 80, local area network 66 could be used in place of WAN 80.

In the exemplary embodiment, any employee 74 or customer/supplier 76 having a work station 82 can access server sub-system 32. One of customer devices 34 includes a work station 84 located at a remote location. Work stations 82 and 84 are personal computers including a web browser. Also, work stations 82 and 84 are configured to communicate with server sub-system 32. Furthermore, fax server 58 communicates with employees 74 and customers/suppliers 76 located outside the business entity and any of the remotely located customer/supplier systems, including a customer/supplier system 86 via a telephone link. Fax server 58 is configured to communicate with other work stations 68, 70, and 72 as well.

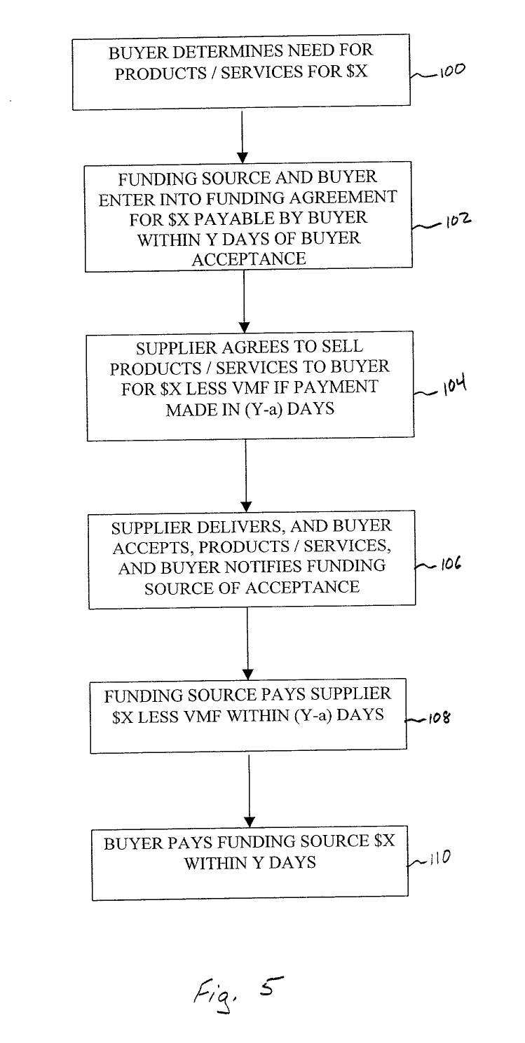

FIG. 5 is a flow chart illustrating exemplary process steps for initiation and completion of a transaction. The process illustrated in FIG. 5 is exemplary only, and illustrates one embodiment of purchasing in accordance with the present invention. Additional embodiments are described herein.

As shown in FIG. 5, a buyer typically determines a need for products/services 100. The buyer also generally knows how much such products/services will cost, $X. At this point in time, the buyer also knows the payment terms desired, e.g., pay $X within Y days of delivery.

If the buyer is new to the exchange, the buyer initiates contact with the funding source, e.g., via the exchange or otherwise, to arrange for a credit line 102. As explained above, many different processes and metrics can be utilized in determining whether the particular buyer qualifies for a certain level of funding. For example, if a particular buyer has entered into previous funding arrangements with the funding source, then the payment history on those agreements can be used. In addition, credit history information for a particular buyer can be purchased, for example, from Dun & Bradstreet and other credit bureaus. Credit information that can be used includes the industry code for the buyer, agency ratings, and balance sheet information. The funding source generally requires that the funding be subject to an acceptable level of risk. The systems and methods described herein are not limited to any one, or combination, of such risk determination methodologies and metrics.

With the funding for the transaction in place, the buyer evaluates possible suppliers and then enters into a contract to secure products from a selected supplier 104. The supplier also is informed of the funding. The basic terms of the transaction provide that the upon the buyer's acceptance of the goods/services, the buyer notifies the funding source of acceptance and the funding source is then authorized to make payment 106. Provided that the funding source makes payment within (Y-a) days 108, then the supplier agrees (e.g., via the pre-payment wizard described above) to price reduction, i.e., the sales price is reduced by the VMF. The buyer, however, is not required to make payment to the funding source for Y days. That is, the buyer pays the funding source $X within Y days 110.

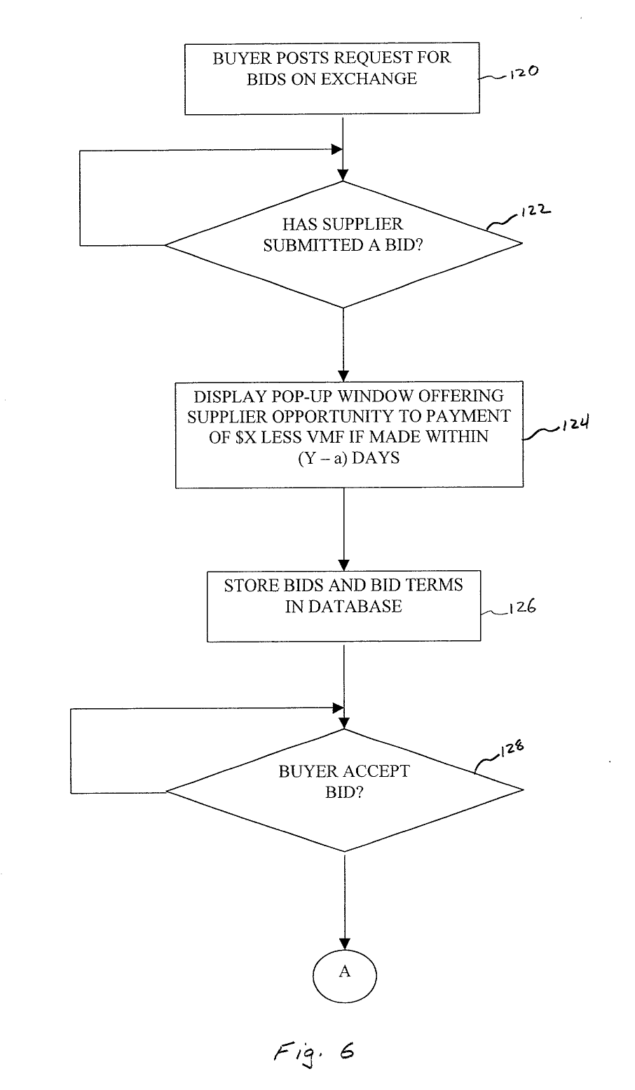

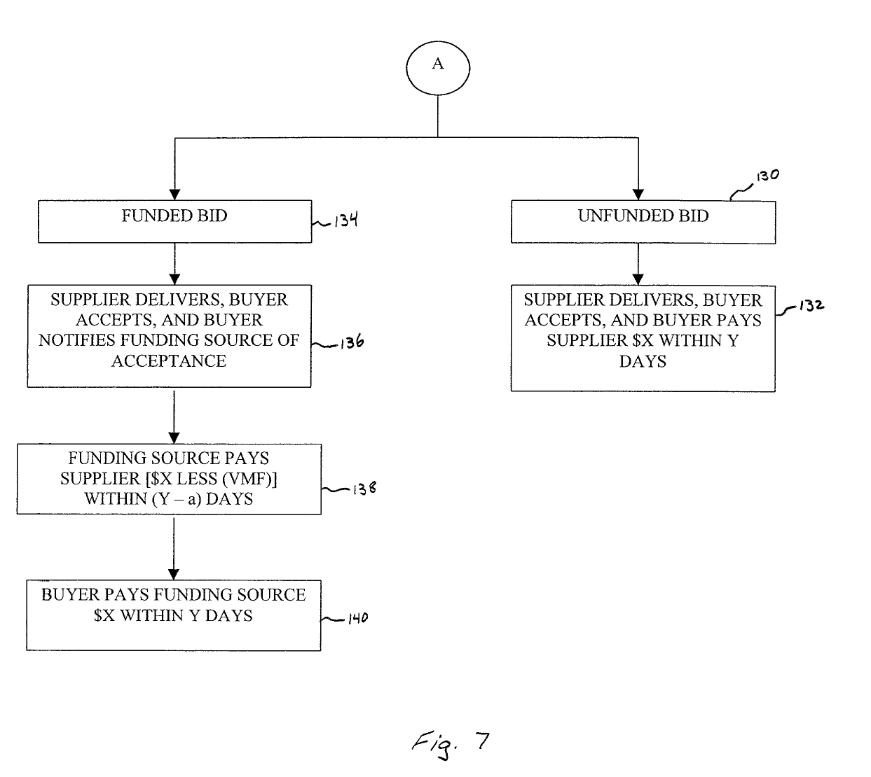

FIGS. 6 and 7 illustrate another embodiment of process steps for a transaction performed via a system such as system 50. Although the process illustrated in FIGS. 6 and 7 can be practiced utilizing many different systems, the process is described herein in the context of system 50. Generally, system 50 is configured to enable interconnectivity for electronic bidding by a plurality of suppliers against bids posted by a plurality of buyers, automated risk assessment for automated funding, electronic acceptance of bids, electronic invoicing, as well as electronic payment. System 50 is sometimes referred to herein as an exchange. Such functionality can be performed, for example, utilizing an Internet communications link. The process illustrated in FIGS. 6 and 7 is not limited to any one particular methodology for performing such functions, and many different methodologies can be utilized. Therefore, the methodologies and metrics described below are exemplary only.

Referring specifically to FIG. 6, buyers post requests 120 for quotes in exchange 50 via, for example, on of workstations 84. The RFQ is stored by the database server and is accessible to potential suppliers who also access exchange 50. The RFQ also includes an indication by the funding source that the buyer is approved for this transaction, and the supplier may request pre-payment of the invoice for the purchase. Such an indication is provided by the buyer, for example, by submitting a funding number which notifies the supplier that the transaction will be covered by an exchange funding service.

A plurality of suppliers access exchange via, for example, workstations 84 and can review the RFQs. Application server 84 is configured, for example, to categorize the bids by service type and product type. Therefore, suppliers can access certain categories of products and services of interest.

Upon submission of a quote, or bid, 122 by a supplier, application server 52 determines whether the particular buyer has elected to obtain funding for the purchase of all particular goods/services, and if so, causes to be displayed to the supplier at the supplier workstation a pop-up window 124 which extends pre-payment terms, i.e., the pre-payment wizard. For example, if the supplier bid is for $X payable within Y days of delivery/acceptance, the pop-up window includes an option in which the supplier receives $X less the VMF and in return, receives payment within (Y31 a) days. An exemplary embodiment of determining whether a particular buyer is eligible for such funding, and the particular manner in which the pre-payment terms are generated, are described below in more detail.

If the supplier accepts the pre-payment service terms and conditions, and chooses to utilize the funding option of the transaction, the supplier will see the VMF terms for (Y−a) days or a term of (Y−a, b or c) days. Such terms are stored 126 along with other portions of the bid by database server 36. If the supplier rejects the proposed pre-payment terms, the bid as originally entered is stored by database server 36.

The buyers can access the bids submitted in response to the requests for bids and stored by database server 36. Upon review of the various bids, the buyer can then accept a bid 128 via the exchange. Upon acceptance of the bid, an e-mail is sent to the winning supplier by application server 54 via mail server 62. A fax also can be sent to the winning supplier via fax server 58 and web server 56.

As shown in FIG. 7, if the accepted bid is not funded 130, then the supplier delivers, the buyer accepts, and the buyer pays the supplier $X within Y days 132. Such payment can be made via the exchange or otherwise. If the accepted bid is funded 134, the supplier then delivers the services/goods to the buyer. Upon delivery/acceptance, the buyer notifies the funding source 136, via exchange 50. The funding source then pays the supplier (e.g., the payment can be made electronically via the exchange) an amount equal to $X less the VMF within (Y−a) days 138. The buyer then pays the finding source (e.g., such payment also can be made via the exchange) an amount equal to $X within Y days 140.

With respect to determining whether a particular buyer is eligible for funding for a transaction arising from a specific request for bid, and in one embodiment, each buyer is pre-qualified for participation in the exchange at the time the buyer subscribes to the exchange. Qualification of new and existing buyer is described above. In addition, and at the time of posting a bid request, exchange 50 accesses (e.g., via the internet) publicly accessible databases as well as databases accessible to the funding source to retrieve data relating the liquidity of the buyer. By comparing the more current data to pre-defined metrics, a particular request for bid from a buyer can be qualified or disqualified. For example, if a credit report indicates that a particular buyer has a lower credit rating than the rating at the time the buyer was pre-qualified for the exchange, the particular request for bid submitted by the buyer which triggers obtaining the credit report may be disqualified from funding.

If a particular request for bid by a buyer is qualified, an expected default frequency (EDF) is established by application server 54 for the buyer. The EDF is generated utilizing the buyer payment history and credit history. The payment history data can be obtained, for example, by the funding source from the funding source's own database. Specifically, if a particular buyer has entered into previous funding arrangements with the funding source, then the payment history on those agreements can be used. In addition, credit history information can be purchased, for example, from Dun & Bradstreet and other credit bureaus. Credit information that can be used in determining an EDF includes the industry code for the buyer, agency ratings, and balance sheet information. Using the payment history and credit history, an EDF for a particular buyer is generated. The EDF is used, as described below in more detail, in determining the payment terms (i.e., the variable merchant fee and due date).

In addition to qualifying buyers for participation in the exchange and for each bid request, at the time a supplier submits a bid, application server 54 determines the payment term option(s) to be presented to the supplier. In one specific embodiment, suppliers are categorized by the buyers as being strategic, semi-strategic, or non-strategic to establish a three tier system. Of course, in alternative embodiment, fewer or more tiers can be utilized. The supplier information stored by database server 36 includes a record of which particular tier the supplier falls within.

Also, the funding source establishes a required annual percentage rate (APR) by tier. In an exemplary embodiment, the funding source selects the APR based on the borrowing rate, the transaction costs, and a risk adder. For example, a Tier 1 supplier transaction may be assigned an APR of 10%, a Tier 2 supplier transaction may be assigned an APR of 11.50%, and a Tier 3 supplier transaction may be assigned an APR of 13%.

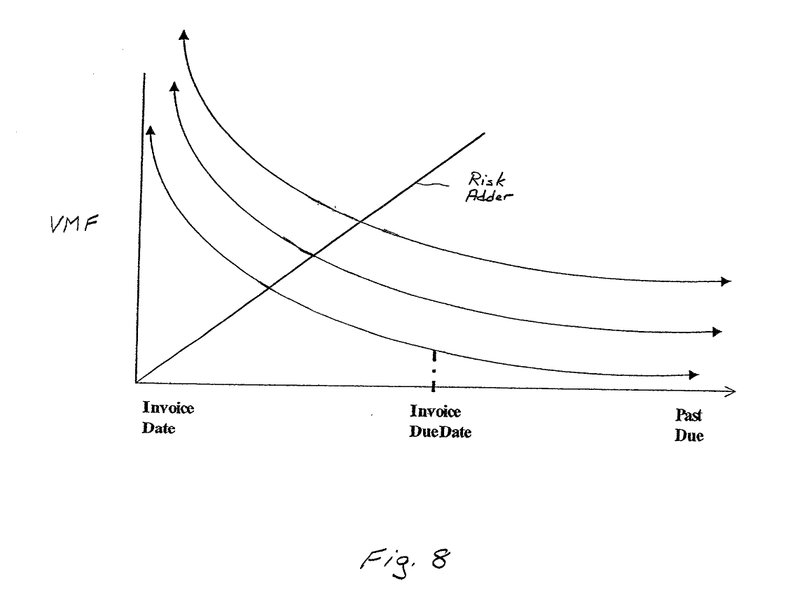

With information about the buyer, the supplier, the amount of funding required for the transaction, and the identified supplier invoice due date, application server 54 then determines a VMF based on a payment due date. For example, and referring to FIG. 8, the lower curve is for Tier 1 suppliers, the higher curve is for Tier 3 suppliers, and the middle curve is for Tier 2 suppliers. The curves for each supplier are generated based on the buyer EDF and the funding source determined APRs. Specifically, the curves represent the return, or VMF, required by the funding source for funding the purchase. The return required by the funding source is a function of the EDF, which represents the credit worthiness of the buyer. In one specific embodiment, the Risk Adder is determined in accordance with:

EDF×[Weighting Function]=Risk Adder,

where the Weighting Function is selected by the particular funding source based on factors such as how much the particular funding source desires the EDF to impact APR. The APR is then determined in accordance with:

Risk Adder+Cost Of Money (e.g., Prime Rate)+Transaction Costs=APR.

The risk adder increases by tier. The curve for each tier is a function of the funding source requiring a higher return the earlier payment or conversely, the VMF the supplier agrees to is higher based on how early the supplier desires payment since the time period required for the financing is increased as compared to if the supplier requests payment later.

More specifically, and as shown in FIG. 8, for a particular invoice due date, the VMF required increases as the funding time increases (i.e., the earlier the invoice is approved by the buyer versus the invoice due date) such that the supplier is paid at the earliest possible moment, the VMF increases. As also shown in FIG. 8, for a particular buyer/supplier relationship, depending on the risk associated with the particular buyer, i.e. a higher risk buyer results in a higher VMF requirement than a lower risk buyer, the curves can move out due to the risk adder.

As explained above, once a particular supplier has submitted a proposed bid, application server 54 then prompts the supplier (e.g., via a wizard) to select whether pre-payment terms are desired. The supplier can then select a date for payment from the wizard and using the information as explained above, server 54 determines the VMF required to support such pre-payment. The supplier can then select a desired pre-payment date.

Although specific embodiments are described herein, there are many potential variations from such embodiments. For example, as described above, the buyer may post a request for bids, a request for quotes, or purchase orders on the exchange and receive responses from suppliers. The various embodiments, however, are not limited to the referenced specific legal instrument used to initiate and finalize the purchase transaction. Generally, the systems and methods provide that a funding source earns a variable merchant fee in return for funding a purchase by a buyer from a supplier who accepts pre-payment terms. The merchant fee is variable in that it is dependent upon the particular buyer as well as the pre-payment date desired by the supplier.

While the invention has been described in terms of various specific embodiments, those skilled in the art will recognize that the invention can be practiced with modification within the spirit and scope of the claims.

What is claimed is:

1. A method for establishing a pre-payment arrangement for an electronic funded purchase transaction, said method comprising the steps of:
prompting a supplier to select pre-payment terms;
determining whether a supplier is registered for pre-payment transactions; and
determining pre-payment terms.

2. A method in accordance with claim 1 further comprising the step of registering a supplier if the supplier is not registered for pre-payment transactions.

3. A method in accordance with claim 1 wherein said step of determining pre-payment terms comprises the step of generating an annual percentage rate.

4. A method in accordance with claim 3 wherein said annual percentage rate is generated utilizing at least one of a supplier tier, buyer payment history, and buyer credit history.

5. A pre-payment wizard configured to:
prompt a supplier to select pre-payment terms;
determine whether a supplier is registered for pre-payment transactions; and
determine pre-payment terms.

6. A pre-payment wizard in accordance with claim 5 wherein said wizard is further configured to register a supplier if the supplier is not registered for pre-payment transactions.

7. A pre-payment wizard in accordance with claim 5 wherein said wizard is further configured to determine pre-payment terms by generating an annual percentage rate.

8. A pre-payment wizard in accordance with claim 7 wherein said annual percentage rate is generated utilizing at least one of a supplier tier, buyer payment history, and buyer credit history.

9. A computer-readable medium, comprising:
a record of a buyer expected default frequency; and
a record of a supplier tier designation.

10. A computer-readable medium according to claim 9 further comprising a record of an annual percentage rate.

11. A computer-readable medium according to claim 10 further comprising a record of a variable merchant fee determined utilizing at least one of said default frequency record, said supplier tier designation, and said annual percentage rate.

12. A system comprising:
means for prompting a supplier to negotiate pre-payment terms; and
means for generating a variable merchant fee based on a pre-payment date selected by the supplier.

13. A system according to claim 12 wherein said means for generating the variable merchant fee comprises means for identifying a pre-assigned annual percentage rate that applies to the supplier.

14. A system according to claim 13 wherein the annual percentage rate is pre-assigned based on at least one of a borrowing rate, transaction costs, and a risk adder.

15. A system according to claim 6 wherein said means for generating the variable merchant fee comprises means for determining an expected default frequency of a buyer.

16. A method for facilitating a purchase transaction between a buyer and a supplier, said method comprising the steps of:
extending funding to a buyer; and
securing pre-payment terms from a supplier.

17. A method according to claim 16 wherein a funding agreement with the buyer requires the buyer to pay a purchase price ($X) within (Y) days of delivery.

18. A method according to claim 17 wherein the pre-payment terms provide that the purchase price ($X) less a variable merchant fee is to be paid on a prepayment date earlier than within (Y) days of delivery.

19. A method according to claim 18 further comprising the step of upon receipt of notice acceptance from the buyer, paying the supplier purchase price less the variable merchant fee on the prepayment date.

20. A method according to claim 16 further comprising the step of receiving payment by the buyer.

21. A system comprising:
a database for storing buyer information and supplier information;
an application server coupled to said database and accessible to buyers and suppliers, said application server configured to:
post requests for quotes in the database;
post quotes in response to the requests for quotes in the database; and
prompt a supplier to negotiate pre-payment terms.

22. A system according to claim 21 wherein said buyer information comprises an expected default frequency.

23. A system according to claim 21 wherein said supplier information comprises a tier designation.

24. A system according to claim 21 wherein said application server is further configured to generate a variable merchant fee based on a pre-payment date selected by the supplier.

25. A system according to claim 24 wherein to generate said variable merchant fee, said application server identifies a pre-assigned annual percentage rate that applies to the supplier.

26. A system according to claim 25 wherein the annual percentage rate is pre-assigned based on at least one of a borrowing rate, transaction costs, and a risk adder.

27. A system according to claim 21 wherein said application server is further configured to generate a variable merchant fee based on an expected default frequency of a buyer.
